(19) United States
(12) Patent Application Publication
(10) Pub. No.: US 2014/0288943 A1
(43) Pub. Date: Sep. 25, 2014

(54) HEALTHCARE RECALL MANAGEMENT

(71) Applicant: Infosys Limited, Bangalore (IN)

(72) Inventors: Karthikeyan Kaniyur-Subbian, Sathyamangalam (IN); Subrahmanya R. Mruthyunjaya, Bangalore (IN); Rashmi Shenoy, Bangalore (IN)

(73) Assignee: INFOSYS LIMITED, Bangalore (IN)

(21) Appl. No.: 14/170,210

(22) Filed: Jan. 31, 2014

(30) Foreign Application Priority Data
Mar. 21, 2013 (IN) 1238/CHE/2013

(51) Int. Cl. G06Q 50/22; G06Q 30/00

(52) U.S. Cl. CPC G06Q 50/22; G06Q 30/014
USPC 705/2

(57) ABSTRACT

Various technologies related to managing a medical device recall are implemented. Automated recall functions can facilitate an efficient and effective recall process. Full lifecycle of the recall process can be managed including communication with patients and replacement of devices, as well as auditing and regulatory compliance. Via the technologies described herein, healthcare providers can manage a successful medical device recall. Unique device identification, electronic health records, electronic medical records, and nationwide health information networks can be supported. A unique device identifier-centric approach can support a very high degree of automation and avoid errors during any of a variety of segments in the medical device recall life cycle.

### BACKGROUND

The proliferation of medical devices presents a challenge to the healthcare field. While the benefits of such devices cannot be disputed, there is a corresponding responsibility that arises when a device is determined to have a flaw. In the interests of preventing harm to patients, such medical devices are recalled.

However, the sheer volume and variety of medical devices can easily overwhelm traditional infrastructure for tracking such devices. For example, recent device recall efforts have been evaluated and found to fall well short of acceptable success.

At the same time, the number of device recalls is also increasing. Thus, the overall trend is for greater and greater numbers of recalled devices.

Although various approaches have been taken to address such difficulties, there is still a need to provide an efficient and effective way to implement a medical device recall.

### SUMMARY

A variety of techniques can be used for managing a medical device recall effort.

Various aspects of the technologies can be used to support any of a variety of processes involved in the full life cycle of the recall process.

Comprehensive aspects such as recall notifications, relationships between patients and device identifiers, patient communication, device recovery, claims processing, and regulatory compliance can be supported.

A UDI-centric approach can enable a very high degree of automation and avoid errors in processing.

Considerable improvements in the efficiency and effectiveness of the recall process can be realized.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing the medical device recall management technologies described herein.

FIG. 2 is a flowchart of an exemplary method of implementing the medical device recall management technologies described herein.

FIG. 3 is a block diagram of an exemplary system implementing the medical device recall management technologies described herein from a wide perspective.

FIG. 4 is a flowchart of an exemplary method of implementing the medical device recall management technologies described herein from a wide perspective.

FIG. 5 is a block diagram of an exemplary system implementing a healthcare recall management tool.

FIG. 6 is a flowchart of an exemplary method of implementing a healthcare recall management tool.

FIG. 7 is a screenshot of an exemplary patient recall message.

FIG. 8 is a block diagram of an exemplary system implementing a healthcare recall management tool within an electronic medical record system.

FIG. 9 is a flowchart of an exemplary method implementing a healthcare recall management tool within an electronic medical record system.

FIG. 10 is a screenshot of an exemplary recall status dashboard presented within an electronic medical record user interface.

FIG. 11 is a block diagram of an exemplary UDI-centric architecture.

FIG. 12 is a screenshot of an exemplary recall initiation user interface for use with the medical device recall management technologies described herein.

FIG. 13 is a screenshot of another exemplary recall initiation user interface for use with the medical device recall management technologies described herein.

FIG. 14 is a block diagram of an exemplary healthcare recall management tool with diverse UDI-centric functionality.

FIG. 15 is a flowchart of an exemplary method of implementing a healthcare recall management tool with diverse UDI-centric functionality.

FIG. 16 is a screenshot of an exemplary recall reception user interface for use with the medical device recall management technologies described herein.

FIG. 17 is a screenshot of an exemplary home user interface for use with the medical device recall management technologies described herein.

FIG. 18 is a screenshot of an exemplary recall status user interface for use with the medical device recall management technologies described herein.

FIG. 19 is a screenshot of an exemplary device recovery user interface for use with the medical device recall management technologies described herein.

FIG. 20 is a screenshot of an exemplary billing user interface for use with the medical device recall management technologies described herein.

FIG. 21 is a screenshot of an exemplary compliance reporting user interface for use with the medical device recall management technologies described herein.

FIG. 22 is a block diagram of an exemplary use case including search functionality.

FIG. 23 is a block diagram of an exemplary use case including billing functionality.

FIG. 24 is a block diagram of an exemplary database schema for use with the technologies described herein.

FIG. 25 is a block diagram of an exemplary computing environment suitable for implementing any of the technologies described herein.

### DETAILED DESCRIPTION

### Example 1

### Exemplary Overview

The technologies described herein can be used for a variety of healthcare recall management scenarios. Adoption of the technologies can provide an incredible improvement in the overall recall process, leading to benefits for a wide variety of stakeholders.

The technologies can be particularly helpful to patients who encounter a recalled device. Healthcare providers can also greatly benefit from the technologies because they enjoy access to technologies that allow more crisp management of the recall process and error avoidance, including robust compliance reporting. Payers can also benefit due to record accuracy, which encourages fraud avoidance. Other stakeholders can benefit as described herein.

### Example 2

### Exemplary System Employing a Combination of the Technologies

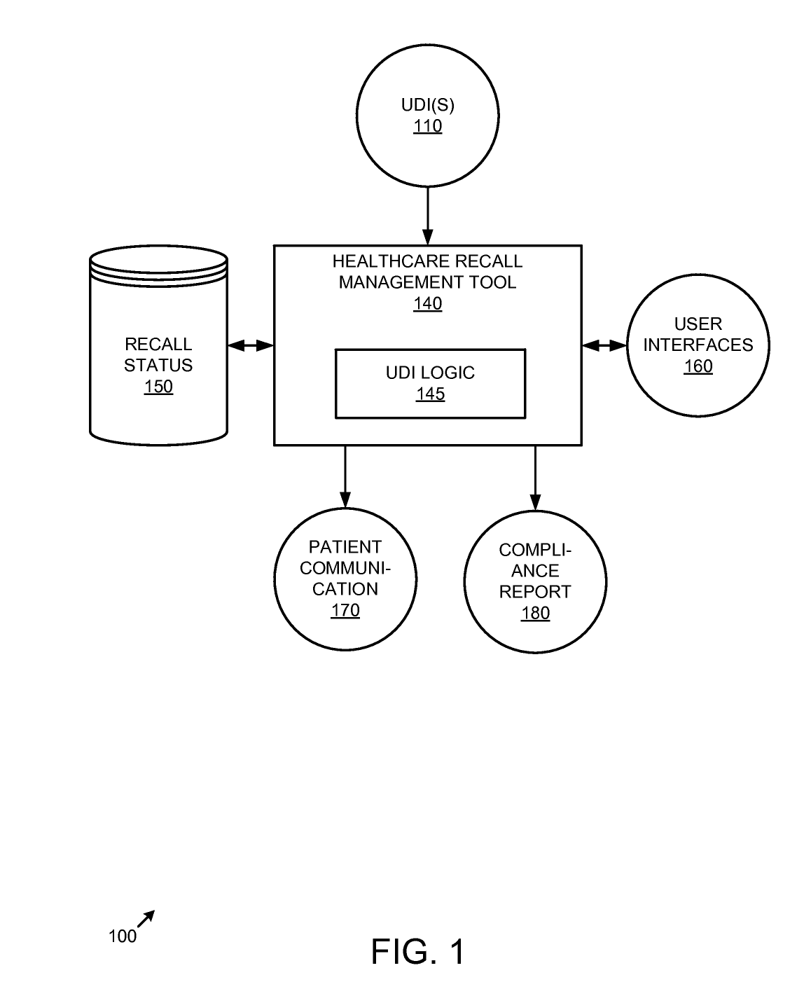

FIG. 1 is a block diagram of an exemplary system 100 implementing the medical device recall management technologies described herein. In the example, one or more computers in a computing environment implement a medical device recall tool 140.

The tool 140 accepts one or more unique device identifiers 110.

The tool incorporates UDI logic 145 that processes the unique device identifiers 110 and is configured to output user interfaces 160, patient communication 170, and compliance reports 180.

A recall status database 150 can be updated to persist status and other information about the recall process.

In practice, any of the systems shown herein, such as system 100 can be more complicated, with additional functionality, more complex inputs, and the like. For example, as described herein, the tool 140 can access other systems (e.g., for patient information or the like).

In any of the examples herein, the inputs, outputs, and tools can be stored in one or more computer-readable storage media or computer-readable storage devices.

### Example 3

### Exemplary Method of Applying a Combination of the Technologies

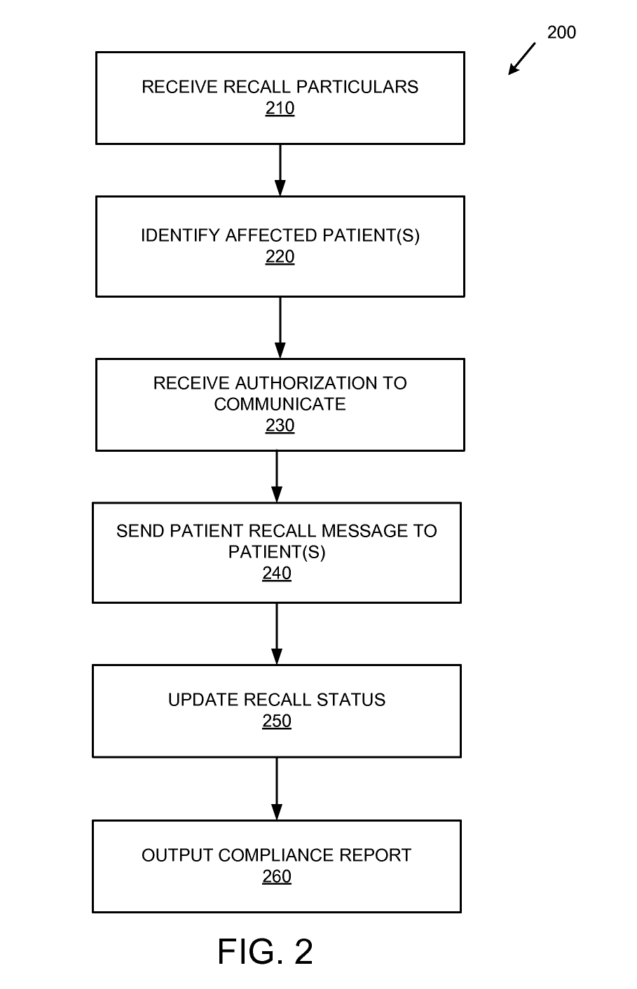

FIG. 2 is a flowchart of an exemplary method 200 of implementing the medical device recall management technologies described herein and can be implemented, for example, in a system such as that shown in FIG. 1. The technologies described herein can be generic to the specifics of operating systems or hardware and can be applied in any variety of environments to take advantage of the described features.

At 210, recall particulars are received. For example, one or more UDIs associated with respective medical devices can be received, along with information about the recall (e.g., a level, who directed the recall, informational messages, and the like).

At 220, the affected patients are identified. As described herein, a UDI can be associated with a patient, and a patient can be associated with one or more UDIs.

At 230, authorization to communicate to the patient is received. As described herein, such authorization can come from an appropriate healthcare provider authority.

At 240, a patient recall message is sent to one or more patients. Such messages can be customized to the particular recipient patient and be provided in any of a number of channels as described herein.

At 250, the recall status is updated in the database. For example, the fact that a message was sent, the device was recovered, or the like can be stored, along with information sufficient for auditing and compliance (e.g., dates, particulars, and the like).

At 260, a compliance report is output. For example, information from the database can be processed to provide mandatory compliance information, such as dates of notification, status of recall, and the like.

Subsequently, if a replacement device is provided, the database can so reflect.

The method 200 and any of the methods described herein can be performed by computer-executable instructions stored in one or more computer-readable media (e.g., storage or other tangible media) or stored in one or more computer-readable storage devices.

### Example 4

### Exemplary Medical Devices

In any of the examples herein, a medical device can be an implantable (e.g., surgically or otherwise) or non-implantable (e.g., handheld, worn, or the like) medical device. Home-based devices, microchip-based drug delivery devices, and the like can also be used. Such devices can include pacemakers, blood glucose monitors, sleep apnea flow generators, hearing aids, and any other of a wide variety of devices. As described herein, the technologies can be expanded to cover devices outside those implanted in the patient or used in home care.

### Example 5

### Exemplary Unique Device Identifier

In any of the examples herein, a unique device identifier (UDI) can take the form of an identifier that uniquely identifies a medical device across different manufacturers, different device types, different years of manufacture, different locations of manufacture, and the like. A weakness in non-unique systems, such as manufacturer serial number, is that they cannot identify a particular device with confidence.

As used herein “unique device identifier” is not limited to a particular implementation and need not be compliant with any particular unique device identification system, as long as the unique device identifier can uniquely identify a medical device within the system. Implementations known as “UDI,” “unique device identification,” “unique device identifier,” or the like can be used.

### Example 6

### Exemplary Nationwide Healthcare Information Network

In any of the examples herein, a nationwide healthcare information network (NHIN) can be any healthcare information network capable of reaching a large number of healthcare providers to communicate healthcare information (e.g., unique device identifiers under recall) and need not be limited to a certain implementation or protocol. Implementations known as “NwHIN,” “NHIN,” or the like can be used.

In practice, a healthcare provider can subscribe to notification types and receive such notifications when sent. Government agencies such as FDA, device manufacturers, and the like can also publish messages on the network. Such messages can include a list of affected unique device identifiers as described herein.

### Example 7

### Exemplary Devices in Inventory

In any of the examples herein, a medical device of any type can be in inventory. For example, a hospital may have a supply of purchased medical devices that are suitable for use in implantable or non-implantable scenarios but not currently allocated to a patient. Such devices can be tracked by unique device identifier and can be associated with the care provider's enterprise resource planning (ERP) application or similar system.

The technologies described herein can be applied to such devices. For example, the unique device identifier of such a device can be associated with an identifier that indicates that the device is not associated with a patient, but rather in inventory. Additional details (e.g., an item location or the like) can also be stored.

Although other techniques can be used, one or more special patient records can be created that correspond to inventory or inventory locations.

In the case of devices in inventory, some aspects of the workflow can be modified accordingly. For example, instead of notifying a patient, a healthcare provider administrator can be notified (e.g., via email) that the devices have been recalled. The healthcare provider's administrators can then send the devices back to the OEM or scrap them. For example, the list of recalled devices can be emailed to a chief medical officer or other authorized person in the provider to take required action. The recall for such devices can then be indicated as completed, even when the device is not associated with a patient. This also helps cleaning up hospital inventory by eliminating the recalled devices.

The technologies described herein can integrate with the healthcare provider's ERP system. A recall message can trigger a reduction in inventory in the care provider's tracking system so that appropriate planning measures can be taken (e.g., additional inventory is ordered, transferred, or the like). Such devices can be made unavailable for allocation to patients. For example, during a provisioning process, a warning message can be displayed that the device is under recall.

Such an approach can help with the recall of devices that happen to be in inventory and avoid use of devices that are under recall.

### Example 8

### Exemplary Healthcare Provider

In any of the examples herein, the technologies can support a wide variety of healthcare providers, including hospitals, clinics, physician practice groups, solo practices, or the like.

### Example 9

### Exemplary Electronic Medical Record System

In any of the examples herein, an electronic medical record system can include an electronic medical record system (EMR), electronic health record (EHR) system, healthcare information system (HIS), or the like.

### Example 10

### Exemplary Recall Status Database

In any of the examples herein, a recall status database can persist information regarding the status of a recall. A wide variety of information, including communication logs, authorization logs, acknowledgement logs, and the like can be implemented.

Data that associates a device with a patient can also be stored in the database, or such data can be obtained via or imported from external databases.

### Example 11

### Exemplary Device Recovery

In any of the examples herein, device recovery can include the process of obtaining the device under recall from the patient. In the case of an implanted device, such recovery can take the form of surgery to explant the device.

In the case on non-implantables, the device can simply be obtained from the patient.

In either case, however, a replacement device can be provided. The technologies described herein can track such replacement as part of the full lifecycle tracking of the recall effort.

The management tool can receive an indication that the medical device has been recovered from the patient, and responsive thereto, an indication that the medical device has been recovered from the patient can be recorded. Details of the recovery (e.g., date, surgery outcome, location, and the like) can also be recorded.

### Example 12

### Exemplary Manufacturer

In any of the examples herein, a device manufacturer can take the form of an original equipment manufacturer (e.g., OEM), maintaining entity, vendor, or the like.

### Example 13

### Exemplary UDI Logic

In any of the examples herein, unique device identifier logic can take the form of logic that can locate a patient associated with a particular medical device, as uniquely identified by a unique device identifier. For example, a database can be consulted to find a patient identifier, patient name, or the like. Such a database may be embedded inside an EMR, EHR, or HIS.

UDI logic can extend to other scenarios, such as when locating communications, acknowledgements, device recovery actions, compliance information, or the like.

### Example 14

### Exemplary System from Wide Perspective

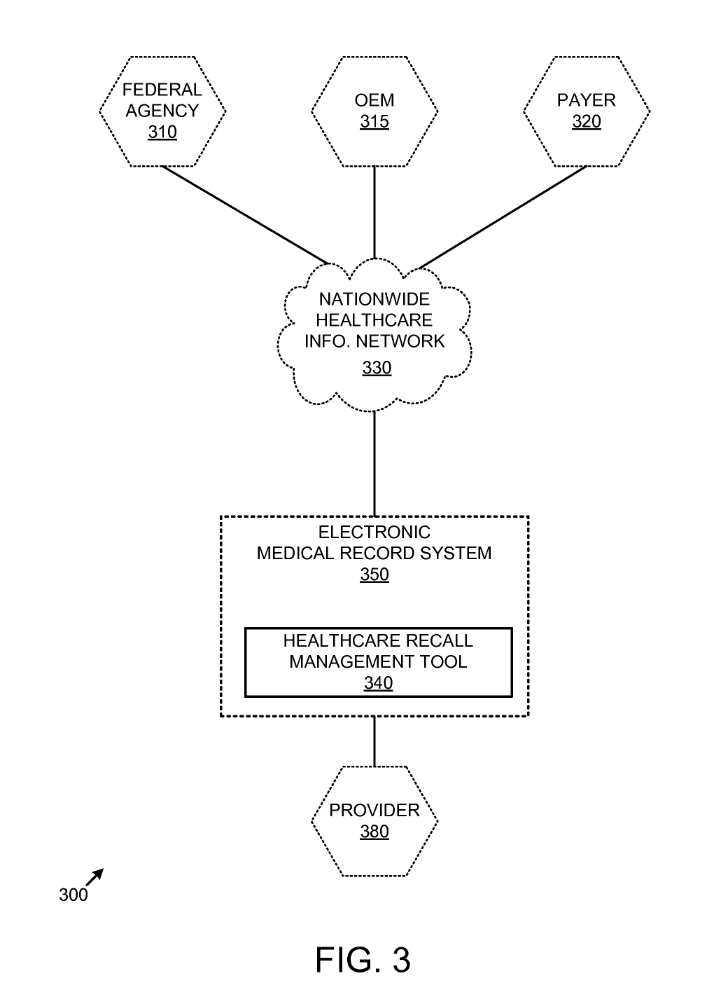

FIG. 3 is a block diagram of an exemplary system 300 implementing the medical device recall management technologies described herein from a wide perspective. In the example, a healthcare recall management tool 340 sits inside an electronic medical record system 350; however, the technologies can also be implemented so that the tool 340 is a standalone tool.

The electronic medical record system 350 is typically operated by a healthcare provider 380. A nationwide healthcare information network 330 provides connectivity between the electronic medical record system 350 and other parties, such as one or more federal agencies 310, one or more device manufacturers 315, payers (e.g., insurance companies) 320, and the like.

As described herein, a variety of features can facilitate accurate and efficient execution of a medical device recall.

### Example 15

### Exemplary Method of Implementing Medical Device Recall Management from Wide Perspective

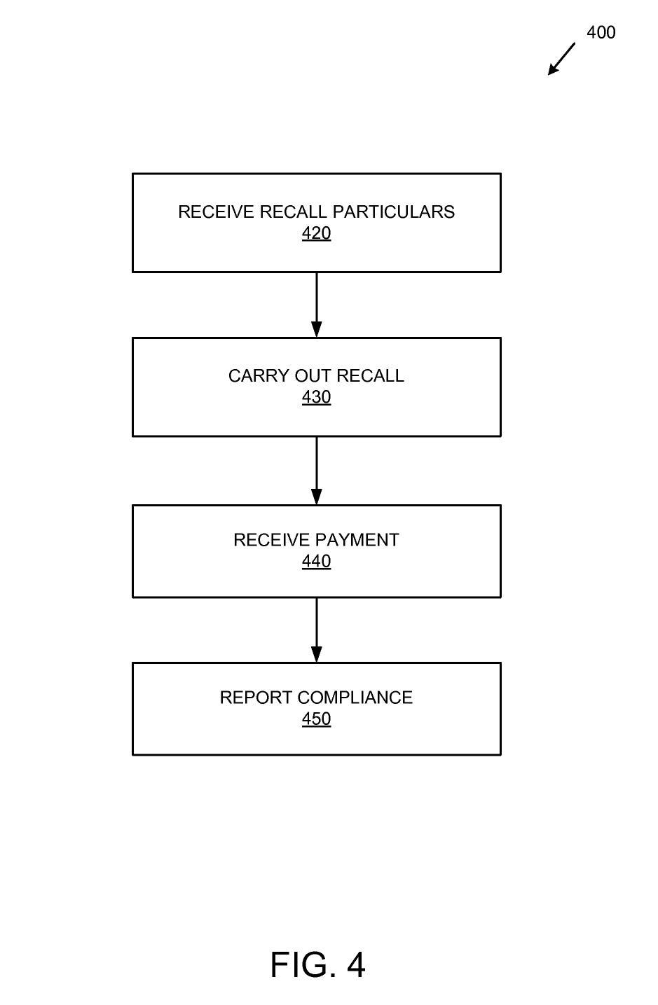

FIG. 4 is a flowchart of an exemplary method 400 of implementing the medical device recall management technologies described herein from wide perspective and can be implemented, for example, in a system such as that shown in FIG. 3.

The method 400 can be initiated after a recall is initiated outside of the healthcare provider (e.g., by a government agency, a device manufacturer, or the like). Recall efforts can then be initiated within the healthcare provider organization.

At 420, recall particulars are received as described herein.

At 430, the recall is carried out. Rich functionality related to patient notification, tracking, and claims processing can be supported.

At 440, payment for services related to the recall is received. Such payment can come from patients (e.g., via copay), payers (e.g., claims settlement), or both.

At 450, compliance is reported.

### Example 16

### Exemplary System Implementing Healthcare Management Tool

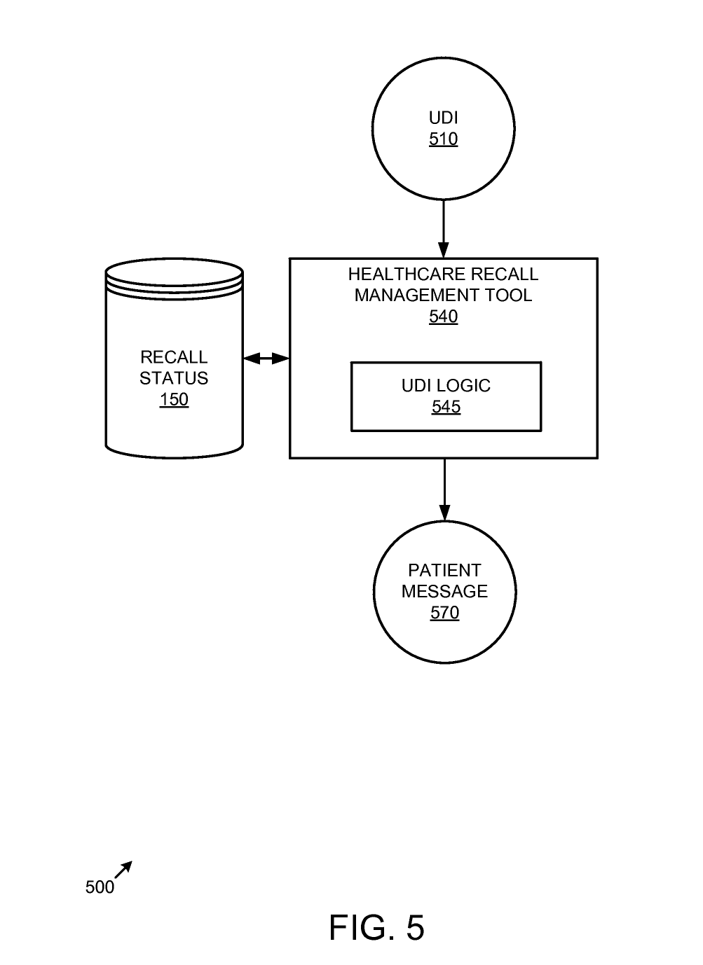

FIG. 5 is a block diagram of an exemplary system 500 implementing a healthcare recall management tool 540 and can be implemented in any of the examples herein to manage the recall process. In the example, the healthcare recall management tool 540 accepts a unique device identifier 510 as input and generates a patient message 570. Recall status database 150 can be updated. The tool 540 can be incorporated into a system such as that shown in FIG. 1 or FIG. 3.

The tool 540 can implement UDI logic 545 as described herein.

The tool 540 can provide a rich set of features for ensuring efficiency and effectiveness of the recall effort. For example, the tool 540 can process patient messages, compliance reports, and user interfaces via a unique device identifier associated with a medical device recall.

The tool 540 can comprise a programming interface accessible by an electronic medical record system.

The database 150 can store recall status for a medical device associated with the unique device identifier. Such a database can be indexed by the unique device identifier.

### Example 17

### Exemplary Method of Implementing Healthcare Management Tool

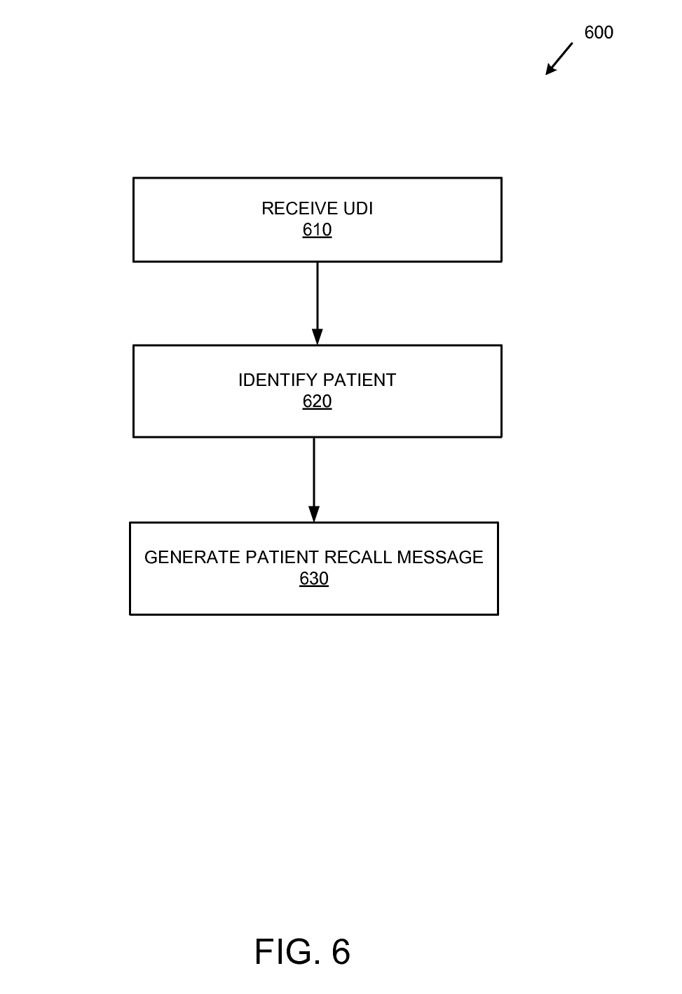

FIG. 6 is a flowchart of an exemplary method 600 of implementing healthcare recall management and can be implemented, for example, in a system such as that shown in FIG. 1, FIG. 3, or FIG. 5.

At 610, a unique device identifier associated with a particular medical device under recall is received. As described herein, such an identifier can be received alone or as part of a bulk recall process (e.g., processing is performed for the unique device identifiers in the bulk load). The association indicates that the patient has the medical device under recall. For example, the device may be implanted in the patient's body, or the patient may possess a non-implantable device. In reality, there can be extreme cases (e.g., the patient has lost the device, the patient has died, or the like) that can also be handled by the system. In some cases, devices may be in inventory. Such situations can be persisted in the recall status database allowing more robust compliance reporting.

At 620, a patient associated with the unique device identifier is identified. Such identification can be accomplished by determining a patient identifier associated with the unique device identifier in a database (e.g., as part of an electronic medical record system or the like).

At 630, a patient recall message is generated. Before the message is sent, authorization from an appropriate healthcare provider authority can be obtained and recorded as described herein. Because the unique device identifier is used to identify the patient, the message is generated via the identifier. The message informs the patient with whom the unique device identifier is associated of the recall.

The patient recall message can be directed to a communication destination as described herein. Thus, a communication destination for the patient with whom the unique device identifier is associated can be determined. Medical records, payer records, or the like can indicate such a communication destination.

The patient recall message can then be sent to the patient. The healthcare recall management tool can send directly or instruct other automated system (e.g., email systems, voicemail systems, telephone systems, or the like) to perform the sending to the communication destination.

After the message is sent, the recall status (e.g., for the unique device identifier) can be updated appropriately.

Compliance reporting can be subsequently performed, and such reporting will show that the message was sent, on what date, what channel, the communication destination, and the like.

In addition to sending the message, a wide variety of other functionality can be performed as described herein, including noting acknowledgement of the message, device recovery, claims processing, and the like.

As described herein, a device can be associated with inventory of a healthcare provider by associating the device's unique device identifier with a special patient record or otherwise indicating that the device is in inventory. When such a unique identifier is received as part of a recall, it can be identified as such, and a message to an administrator of the healthcare provider can be generated informing the administrator of the recall.

### Example 18

### Exemplary Patient Recall Message

In any of the examples herein, a patient recall message can take any of a variety of forms of communication that inform the patient of the recall of a medical device.

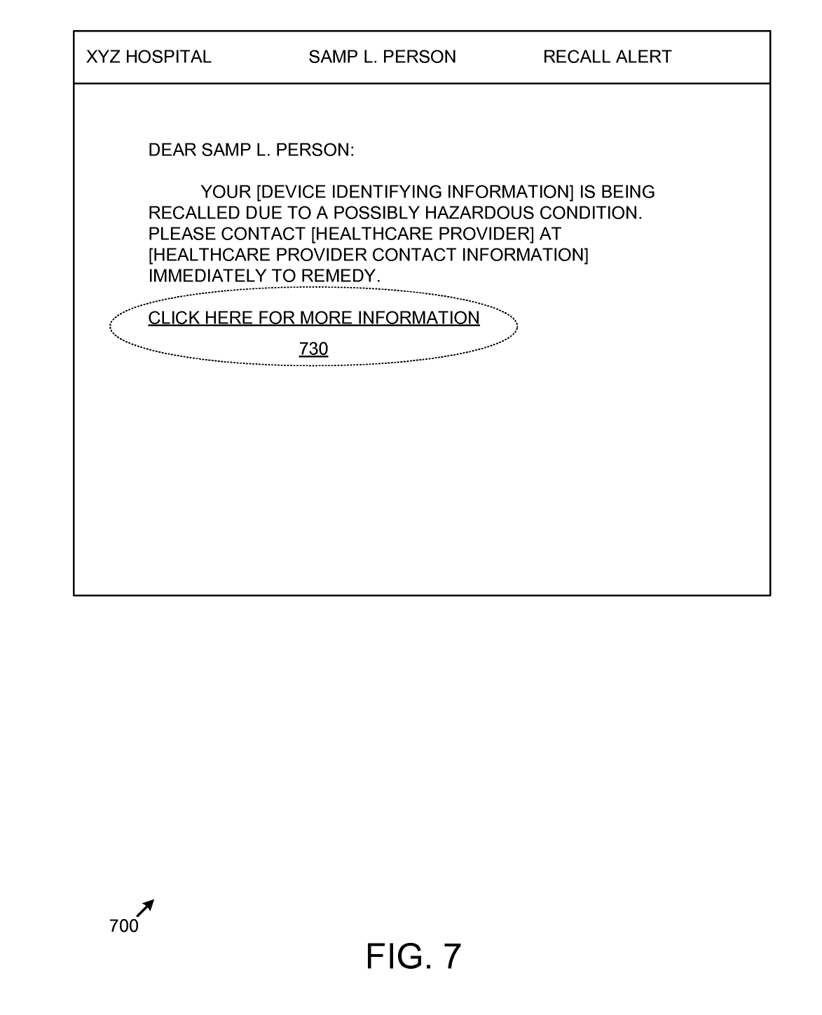

FIG. 7 is a screenshot of an exemplary patient recall message 700 that can be implemented in any of the examples herein.

In the example, device identifying information, and healthcare provider contact information is included in the message 700.

Active content 730 is provided by which the patient can navigate to additional information, acknowledge receipt, schedule an appointment for device recovery, or the like.

Although the example is shown in a particular form, other message types can be supported. For example, telephonic messages (e.g., automated voice notification), text messages (SMS), email messages, browser links, social network messages, physical letters or the like can be implemented to communicate with a patient.

For other message types and channels, acknowledgement can vary (e.g., by pressing numbers, clicking or tapping a user interface, returning a postcard, posting a reply, or the like).

Such a message can also be generated on the healthcare provider premises (e.g., for a patient who visits the facility) on demand and provided (e.g., on screen or in paper form) for consumption by the patient. The patient can be positively identified and receipt of the message can be acknowledged.

### Example 19

### Exemplary Patient Recall Message Communication Destination

In any of the examples herein, a communication destination for a recall message can be determined. In practice, such a destination can be an email address, telephone number, physical address, social network address, or the like. Such destinations can be determined by consulting medical records, customer preferences, customer service accounts, or the like.

Destinations can be prioritized to be contacted seriatim (e.g., if a first message is not acknowledged after a certain threshold period of time) or sent simultaneously.

### Example 20

### Exemplary Message Recording

In any of the examples herein, after a message is sent, the fact that the patient message has been sent can be recorded (e.g., in a log). Such recordation can include recording a patient identifier, the communication destination, and a date the message was sent.

Some messages will be unsuccessful (e.g., bounce). In the case of an email, the email may be returned. In the case of a text message, the message may fail. Even physical mail can be returned.

After receiving a notification that a patient message bounced, an indication that the patient message bounced can be recorded. Responsive to the bounce, a different communication destination, if any on record, can be used.

If no remaining destinations are available, a message can be sent to appropriate healthcare personnel, who can further research the whereabouts of the patient and continue the process.

### Example 21

### Exemplary Patient Acknowledgement

In any of the examples herein, after a patient recall message is sent, the patient can acknowledge receipt. Responsive to such acknowledgement, an indication can be recorded in a log that the patient acknowledges receipt of the message.

As described herein, a message can include active content that has a message identifier. Receiving acknowledgement can include receiving an indication that such active content has been selected.

### Example 22

### Exemplary System Implementing Healthcare Management Tool in EMR

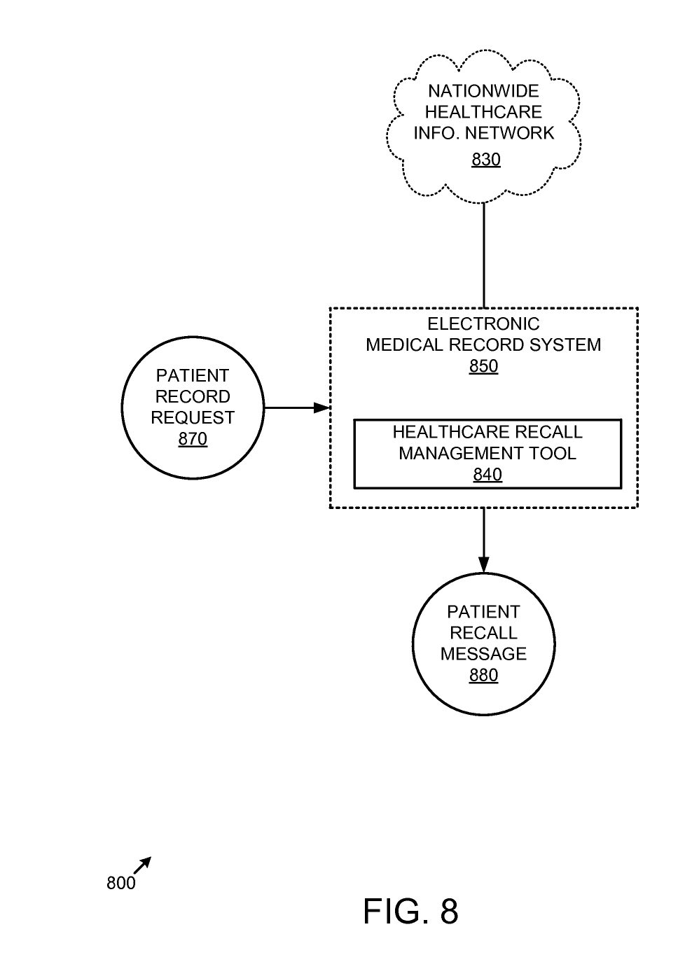

FIG. 8 is a block diagram of an exemplary system 800 implementing a healthcare recall management tool 840 within an electronic medical record system 850. Such a system 800 can be integrated with any of the other systems described herein.

In the example, a healthcare recall management tool 840 sits inside an electronic medical record system 850; however, standalone implementations can be supported.

Information from a nationwide healthcare information network 830 can be accessed by the system 850 and tool 840.

The system 850 is configured to receive a variety of record requests, including patient record request 870. The system 850 can, with assistance from the tool 840, generate an appropriate patient recall message 880.

In this way, recall messages can be provided to patients even when access to medical records is unrelated to the recall of a particular medical device.

### Example 23

### Exemplary Method of Implementing Healthcare Management Tool

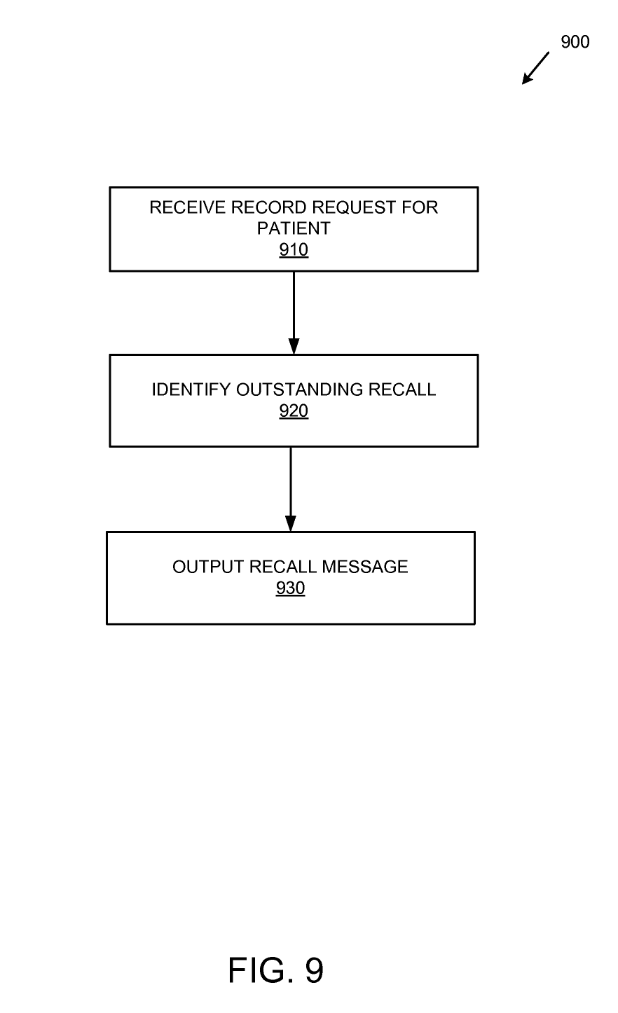

FIG. 9 is a flowchart of an exemplary method 900 of implementing healthcare recall management and can be implemented, for example, in a system such as that shown in FIG. 8.

At 910, a record request for a patient is received. Such a record request can be unrelated to a recall. For example, a routine patient record request can be received. Such a request can be done while scheduling an appointment, providing information to the patient while browsing medical records via a website, or the like.

At 920, an outstanding recall for the patient is identified (e.g., via a UDI of a device that is associated with the patient).

At 930, a patient recall message is output. As described herein, the fact that the patient was notified can be recorded. Acknowledgement of the message can also be obtained and recorded.

The recall message can be output on a record request user interface, even if such an interface is typically unrelated to the recall process.

### Example 24

### Exemplary Patient Recall Message

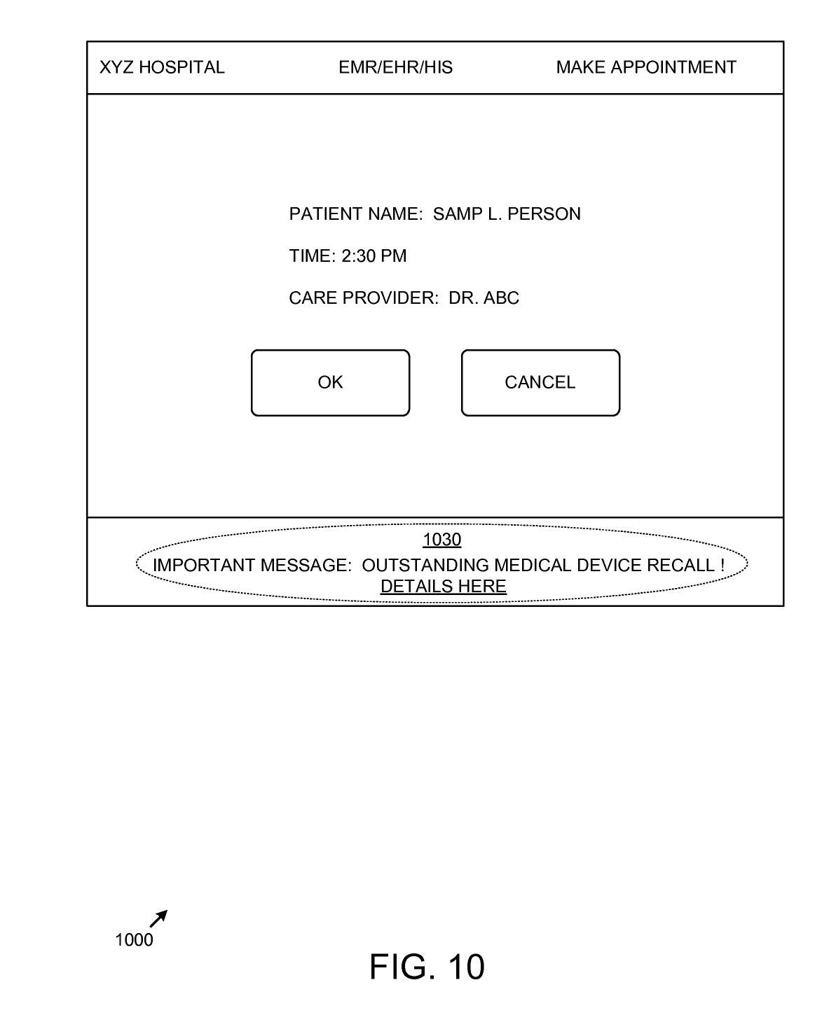

FIG. 10 is a screenshot of an exemplary recall status dashboard 1030 presented within an electronic medical record user interface 1000. Such a status dashboard 1030 can be used to display a patient recall message as described herein.

In the example, the dashboard 1030 is presented as part of a routine patient medical record request user interface 1000. As described herein, such a dashboard 1030 can be displayed as part of any of a variety of user interfaces.

### Example 25

### Exemplary UDI-Centric Architecture

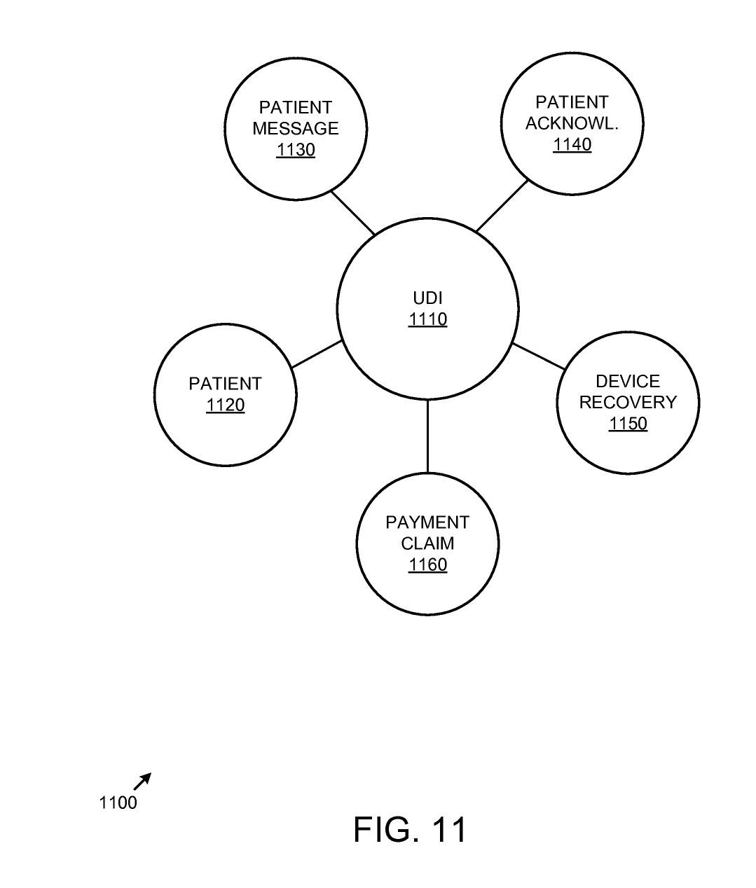

FIG. 11 is a block diagram of an exemplary UDI-centric architecture 1100 that can be implemented in any of the examples herein. A UDI-centric technology can implement any of the features described.

Having a unique device identifier 1110 for a device under recall allows a wide variety of functionality to be orchestrated in an automated and efficient manner. A database can store particulars of the device via reference to the UDI. At the outset, the patient 1120 associated with the device under recall can be determined, allowing identification of communication destinations for the patient, the patient status and location, and the like.

A patient message 1130 can also be more effectively generated because the particulars of the device and patient are available. The device at issue can be positively identified, avoiding confusion if there are two similar or same model devices.

Patient acknowledgements 1140 can also be more effectively processed because the device at issue is positively identified.

Further, device recovery 1150 can be more accurately implemented and tracked because the device itself when recovered can be positively identified as the device under recall.

Still further, the integrity of payment and claims processing 1160 can also be assured because opportunities for error or fraud are avoided, due to the fact that a unique device identifier is associated with a particular device. Such scenarios as double paying, phantom patients, compliance manipulation, and the like can be avoided or detected.

### Example 26

### Exemplary UDI-Centric Recall Initiation User Interface

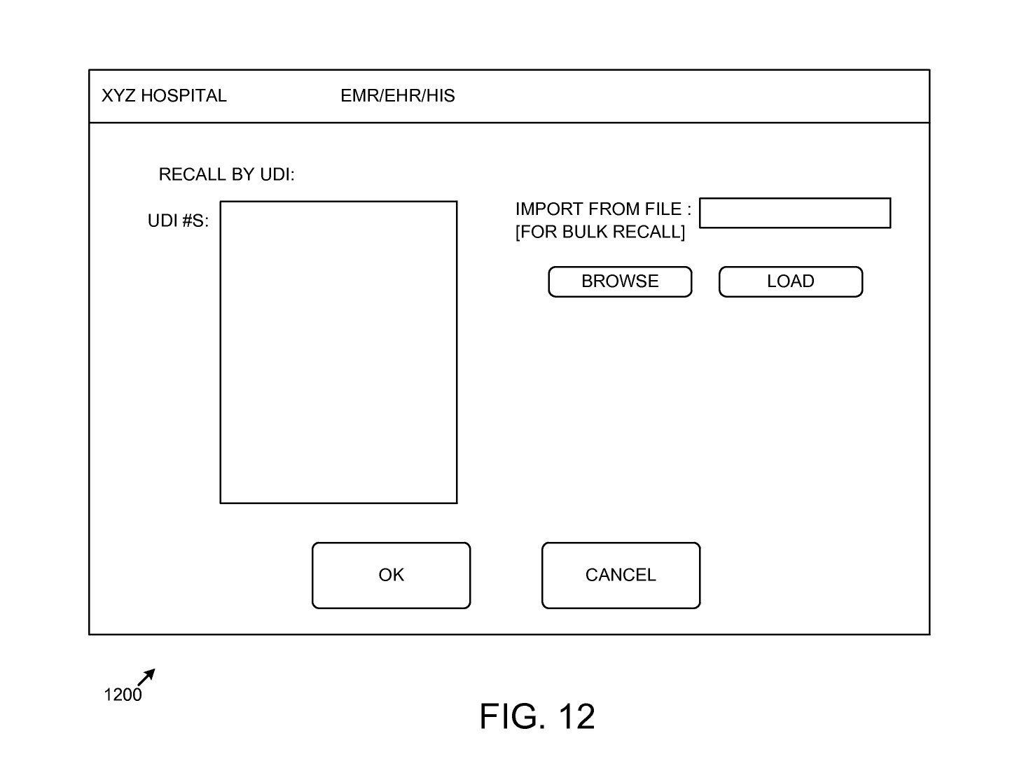

FIG. 12 is a screenshot of an exemplary recall initiation user interface 1200 for use with the medical device recall management technologies described herein. The interface 1200 can be presented by a healthcare recall management tool as described herein, whether integrated into an electronic medical record system or as a standalone tool.

UDI-centric options are presented by which a recall can be initiated at the healthcare provider level. Unique device identifiers can be input manually, imported from a file, or both. “OK” can be activated to proceed to the home (e.g., patient-device information) user interface described herein.

For bulk recall, a file (e.g., CSV, spreadsheet, XML, or the like) can be chosen (e.g., via “Browse”), and “Load” activated.

A user interface by which the recalled devices and patients associated with them can be viewed. From the user interface, a bulk recall notification can be accomplished via a messaging service installed into the electronic medical record system, enterprise resource planning system, or the like.

### Example 27

### Exemplary Recall Initiation User Interface

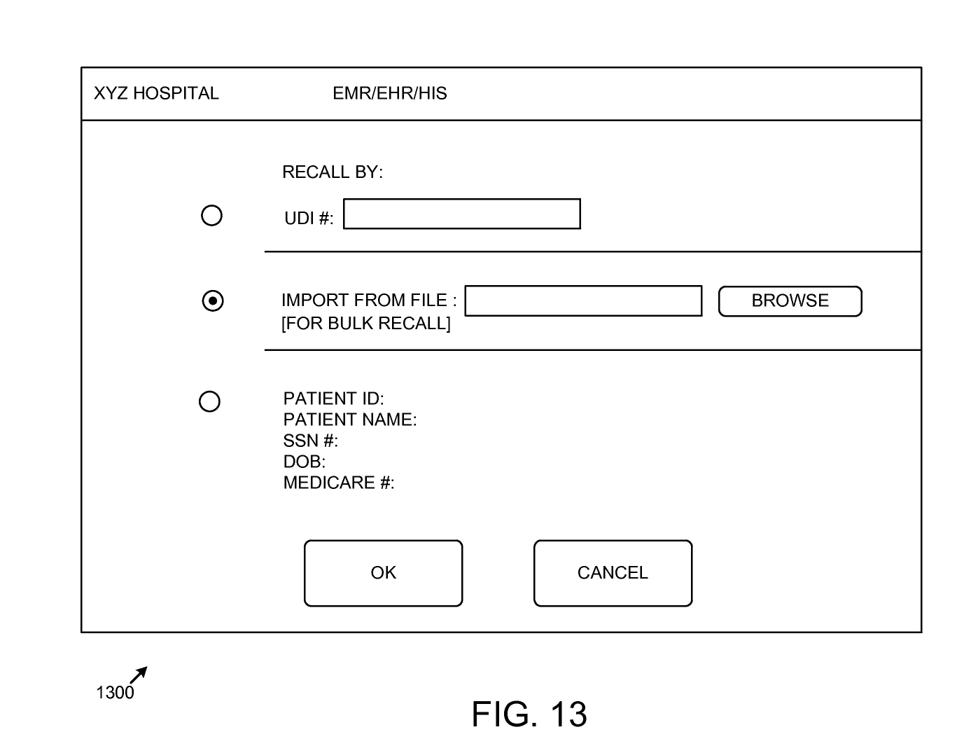

FIG. 13 is a screenshot of another exemplary recall initiation user interface 1300 for use with the medical device recall management technologies described herein. The interface 1300 can be presented by a healthcare recall management tool as described herein, whether integrated into an electronic medical record system or as a standalone tool.

Three possible options are presented by which a recall can be initiated at the healthcare provider level. A patient identifier, name, or other identifier can be input, and “OK” can be activated to proceed to the home (e.g., patient-device information) user interface described herein.

Or, a UDI number can be entered, and “OK” can be activated to proceed to the relevant user interface.

Or, for bulk recall, a file (e.g., CSV, spreadsheet, XML, or the like) can be chosen, and “OK” activated. A user interface by which the recalled devices and patients associated with them can be viewed. From the user interface, a bulk recall notification can be accomplished via a messaging service installed into the electronic medical record system, enterprise resource planning system, or the like.

### Example 28

### Exemplary Healthcare Recall Management Tool

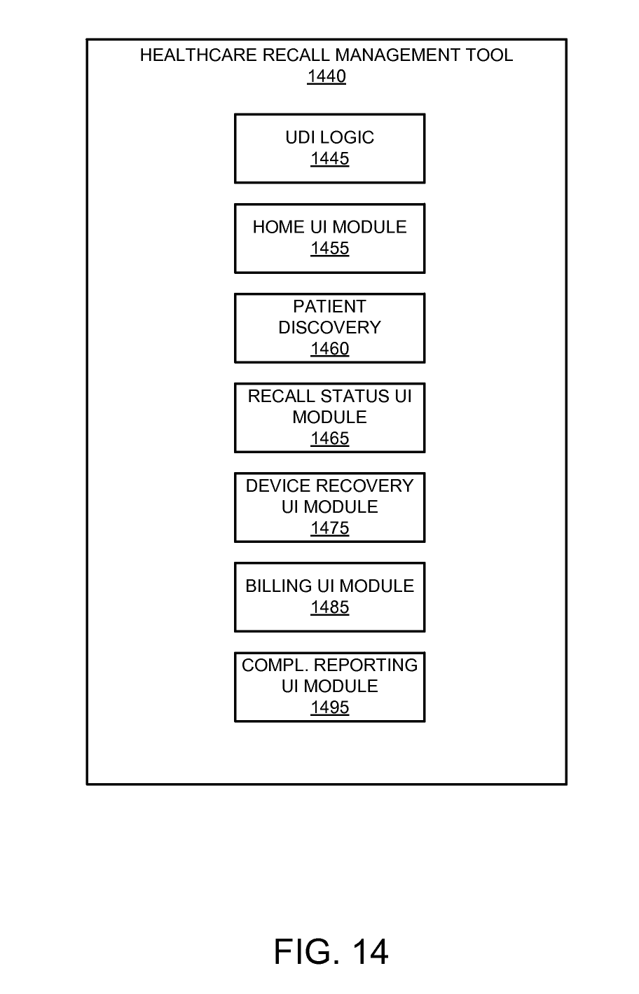

FIG. 14 is a block diagram of an exemplary healthcare recall management tool 1440 with diverse UDI-centric functionality. Such a tool 1440 can be implemented in any of the examples herein. In the example, the tool 1440 includes UDI logic 1445, a home user interface module 1455, a patient discovery module 1455 (e.g., for discovering which patients are related to specified UDIs and thus affected by the recall), a recall status user interface module 1465, a device recovery user interface module 1475, a billing user interface module 1485, and a compliance reporting user interface module 1495, displaying the user interfaces described herein.

In practice, the tool 1440 can support any number of additional features and incorporate a broad range of technologies to support the recall effort.

### Example 29

### Exemplary Healthcare Recall Management Tool Method

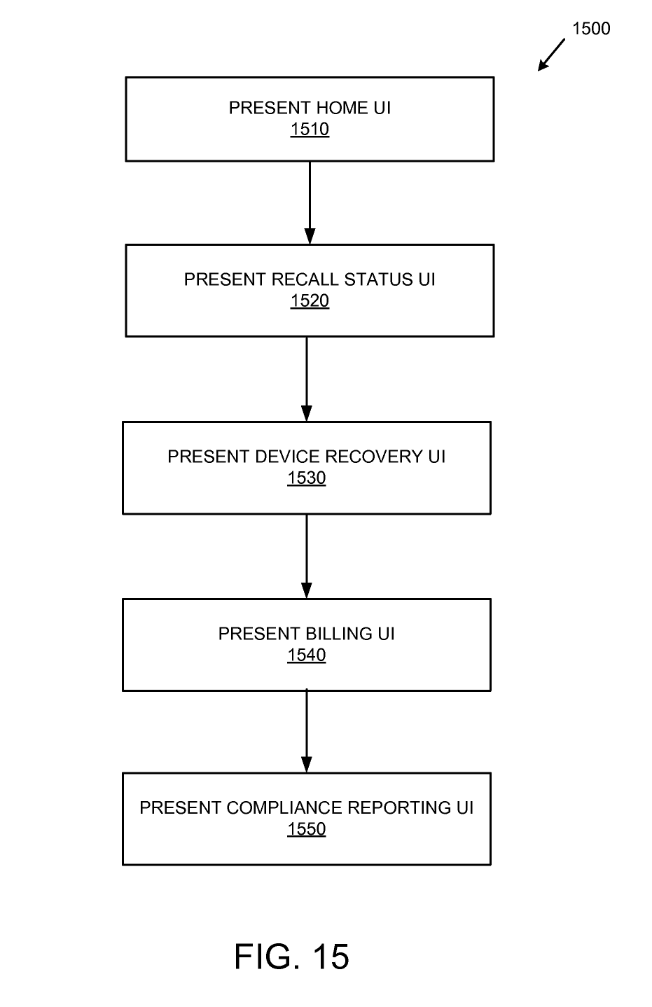

FIG. 15 is a flowchart of an exemplary method 1500 of implementing a healthcare recall management tool with diverse UDI-centric functionality and can be implemented, for example, in a system such as that shown in FIG. 14.

In the example, a home user interface is displayed at 1510.

At 1520, a recall status user interface is displayed. Such an interface can comprise a recall status of a medical device as described herein.

At 1530, a device recovery user interface is displayed. Such an interface can comprise recovery information of the medical device as described herein. Either implantable or non-implantable information can be displayed according to the device type.

At 1540, a billing user interface is displayed. Such an interface can comprise claim information for the medical device as described herein.

At 1550, a compliance reporting user interface is displayed. Such an interface can comprise an indication of reported parameters for the medical device as described herein.

### Example 30

### Exemplary Recall Reception User Interface

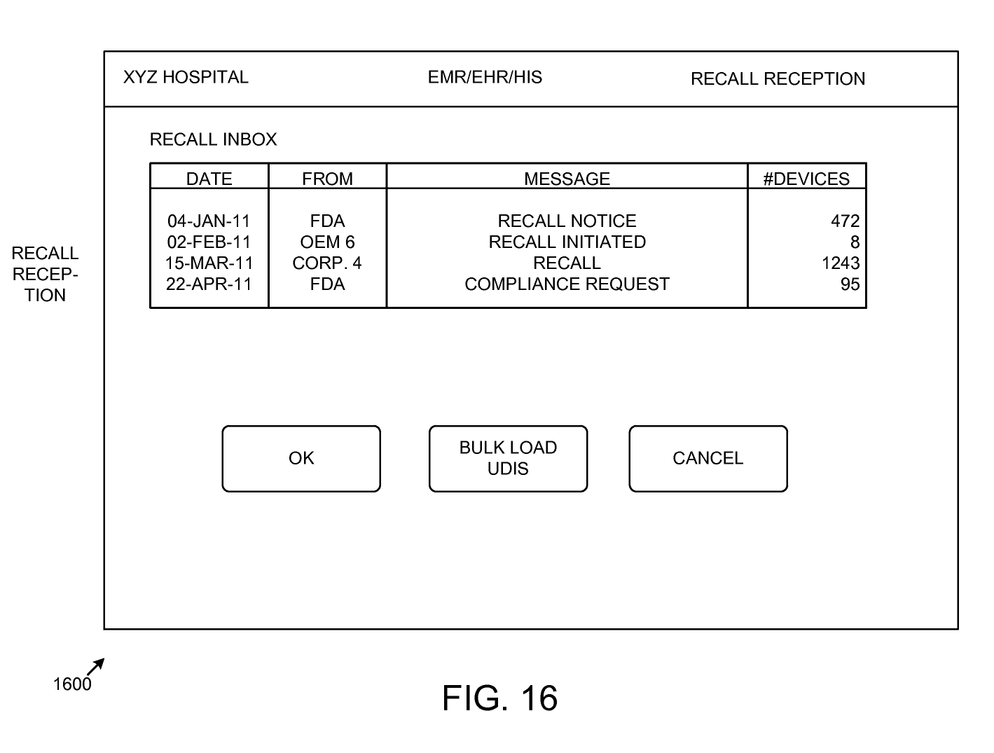

FIG. 16 is a screenshot of an exemplary recall reception user interface 1600 for use with the medical device recall management technologies described herein. The interface 1600 can be presented by a healthcare recall management tool as described herein, whether integrated into an electronic medical record system or as a standalone tool.

In the example, an inbox is provided for reception of messages published on a nationwide healthcare information network. Such messages can include a list of unique device identifiers associated with a recall. The recall management tool can filter messages to those related to a recall and indicate the number of devices affected. The unique device identifiers indicated in the message can be loaded for recall processing as described herein (e.g., to notify associated patients).

### Example 31

### Exemplary Home User Interface

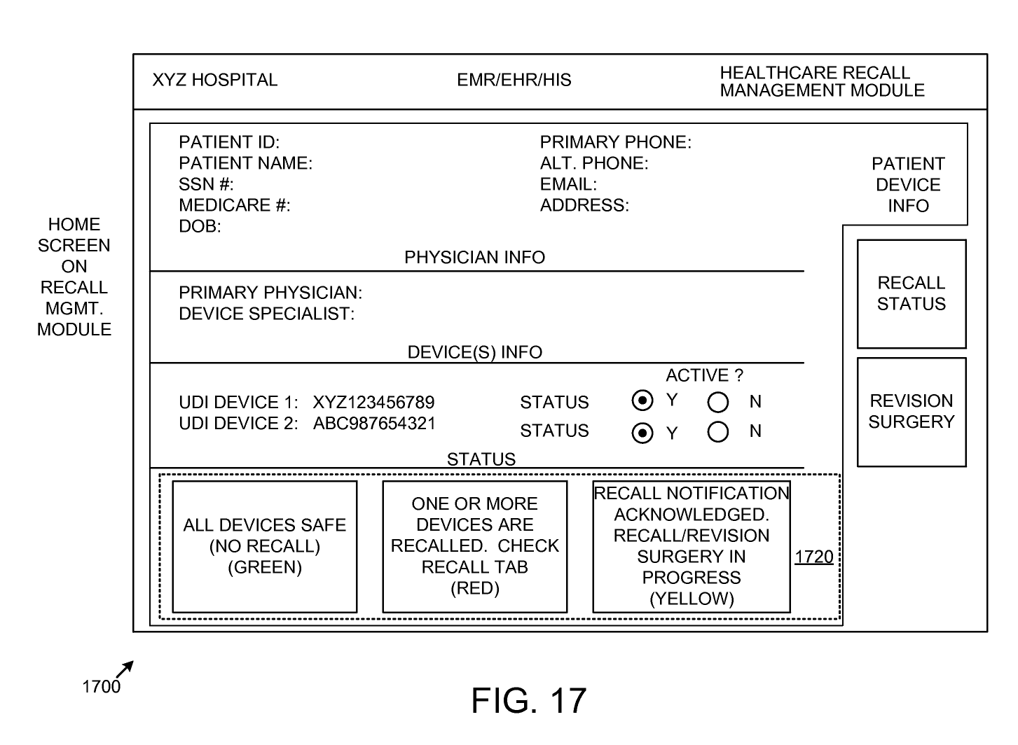

FIG. 17 is a screenshot of an exemplary home user interface 1700 for use with the medical device recall management technologies described herein. The interface 1700 can be presented by a healthcare recall management tool as described herein, whether integrated into an electronic medical record system or as a standalone tool.

The interface 1700 can serve as the home user interface for the healthcare recall management tool. The home user interface 1700 is sometimes called the “patient-device information screen” because it lists information on a patient and medical devices associated with the patient.

The interface 1700 can provide details about a particular patient, the patient's physicians, and a list of devices that are implanted, provided, or assigned to the patient.

Additionally, the interface 1700 can also provide a quick view of the status of each device regarding whether it is active (e.g., device is currently being used and not explanted in the case of an implantable device or discarded in the case of a handheld or home use device) or not. User interfaces following the interface 1700 can be UDI-centric. So, the healthcare recall management tool can simplify the tasks of device assignment, management (e.g., including software updates, firmware updates, or the like), monitoring device health, supply of compatible accessories, recall (e.g., if required), and the like by linking the unique device identifier of one or more devices to the patient (e.g., by identifier or name).

In the example, there is also a recall status dashboard 1720 that shows if devices are not recalled or if any device has been recalled or is currently under recall process. Distinctive portrayal (e.g., color coding) can be used to emphasize an alert if a recall has been initiated.

### Example 32

### Exemplary Recall Status User Interface

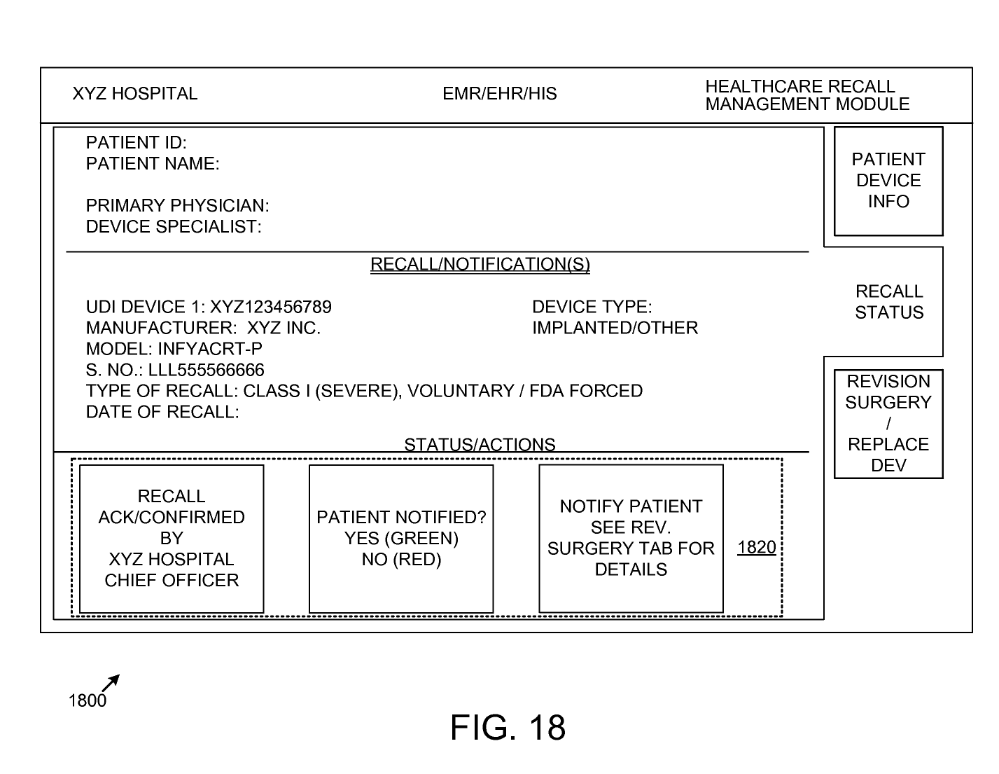

FIG. 18 is a screenshot of an exemplary recall status user interface 1800 for use with the medical device recall management technologies described herein. The interface 1800 can be presented by a healthcare recall management tool as described herein, whether integrated into an electronic medical record system or as a standalone tool.

The interface 1800 contains limited details of the patient and the patient's physician(s). The emphasis is on listing the devices that are recalled (e.g., by the device manufacturer or regulatory authority). The interface 1800 also includes a dashboard 1820 for status and action, where, for the recalled devices, information about the action status for a respective device is displayed. Such actions can include acknowledgement by a hospital authority (e.g., chief medical officer or other authority) to start the recall process, whether the patient has been notified of the patient's device being recalled with details on further steps such as device recovery (e.g., revision surgery or replacement of a non-implanted device). The interface 1800 also allows a user (e.g., physician, clinician, hospital recall administrator) to start the automatic notification process by simply clicking on the “Notify Patient” button. Responsive to activation of the button, a message is sent to patients automatically as described herein.

### Example 33

### Exemplary Device Recovery User Interface

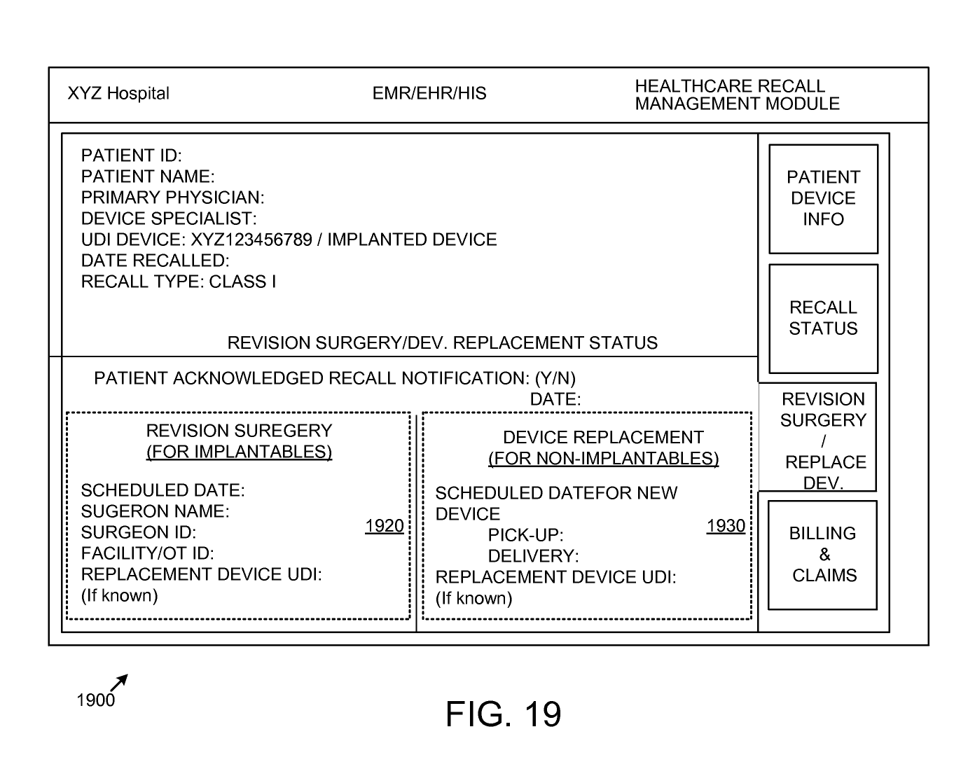

FIG. 19 is a screenshot of an exemplary device recovery user interface 1900 for use with the medical device recall management technologies described herein. The interface 1900 can be presented by a healthcare recall management tool as described herein, whether integrated into an electronic medical record system or as a standalone tool.

The user interface 1900 provides details of revision surgery or device replacement scheduled for the patient for the recalled device. The revision surgery section 1920 is displayed as enabled responsive to determining that the device is an implantable device, and the device replacement section 1930 is displayed as enabled responsive to determining that the device is a non-implantable device. Only one section is enabled per device based on the device type (e.g., the user interface chooses between enabling the two sections based on device type).

### Example 34

### Exemplary Billing User Interface

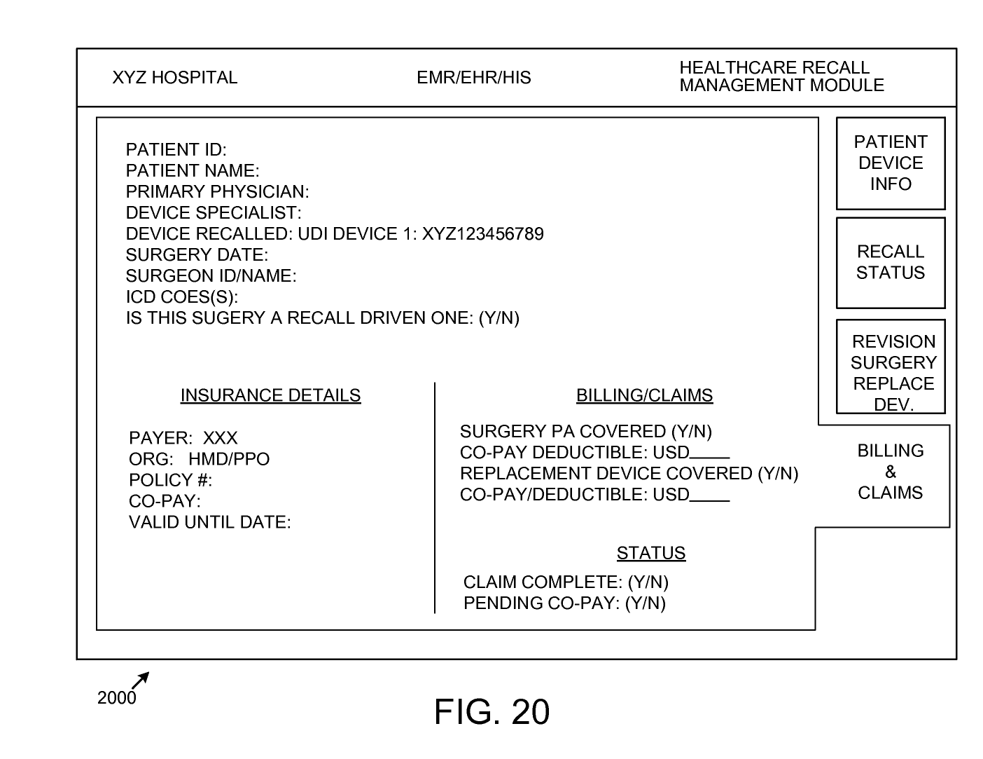

FIG. 20 is a screenshot of an exemplary billing user interface 2000 for use with the medical device recall management technologies described herein. The interface 2000 can be presented by a healthcare recall management tool as described herein, whether integrated into an electronic medical record system or as a standalone tool.

The interface 2000 comprises billing and claims information including procedure codes (e.g., ICD codes), payer information, insurance policy information, and details on how much of the recall revision surgery or device replacement is covered by insurance and how much is out-of-pocket expense for the patient.

The interface 2000 also shows if the revision surgery or device replacement is recall driven (e.g., by the manufacturer, government regulatory agency, etc.) or patient initiated for reasons other than a recall. Depending upon whether the recall is recall driven or patient initiated, the coverage can differ.

Additionally, the interface 2000 can show whether claims and co-pay are complete or not.

### Example 35

### Exemplary Compliance Reporting User Interface

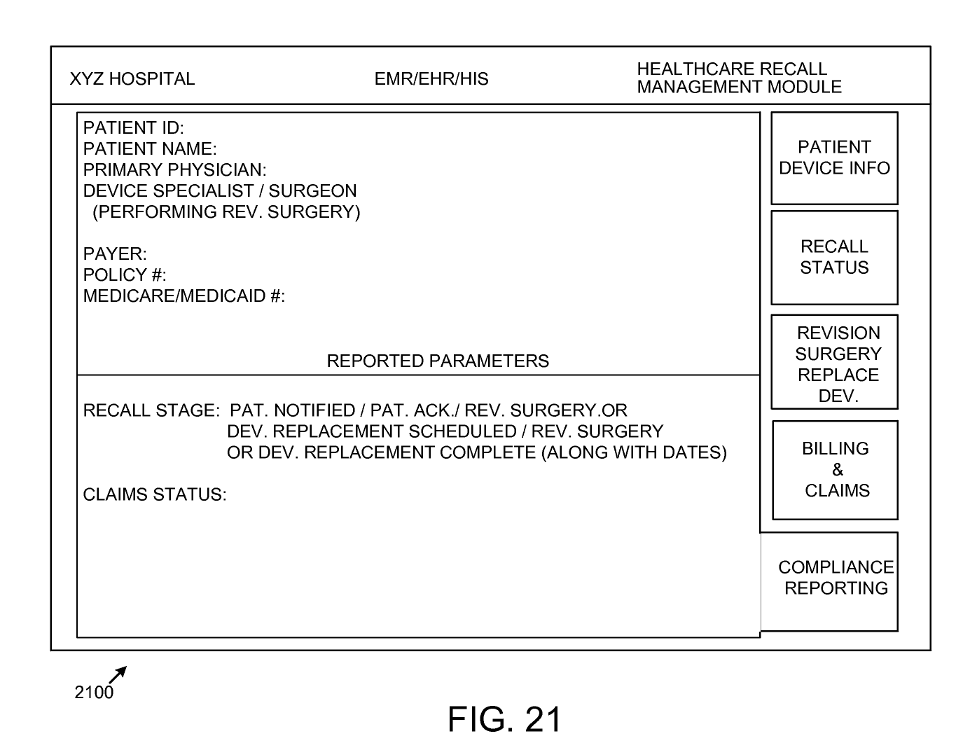

FIG. 21 is a screenshot of an exemplary compliance reporting user interface 2100 for use with the medical device recall management technologies described herein. The interface 2100 can be presented by a healthcare recall management tool as described herein, whether integrated into an electronic medical record system or as a standalone tool.

The user interface 2100 can display details on status of parameters that regulatory authorities require. Such parameters can be saved and shared periodically for meaningful use, compliance, and patient safety management. Using the report parameters, reports can be prepared showing the progress of a recall process from the time the recall notice is sent out to the time of successfully completing the recall for the patients and devices involved.

Automated compliance reporting can be used to address the multi-fold increase in device usage and number of recalls.

In any of the examples herein, responsive to a request for a compliance report, a log of communications with a patient can be output.

A request for a compliance report can be initiated by a regulatory authority (e.g., FDA or the like) or a government agency (e.g., CMS or the like) through a nationwide health information network or similar infrastructure and travel through the hospital health information system and then to the electronic medical record system, and finally to the Healthcare Recall Management module. Because UDI-centric techniques are supported, the process can be highly automated. As a result, real-time automated compliance reporting methods and tools are enabled.

### Example 36

### Exemplary Architecture

The technologies can be implemented via a standard model view controller (MVC) or other architecture while emphasizing the user interface of the healthcare recall management tool. Any appropriate designing technique can be used to invoke the user views based on the various system triggers.

Various use cases can be further described to explain a possible technical working of the healthcare recall management tool.

### Example 37

### Exemplary Use Case: Root/Search UI

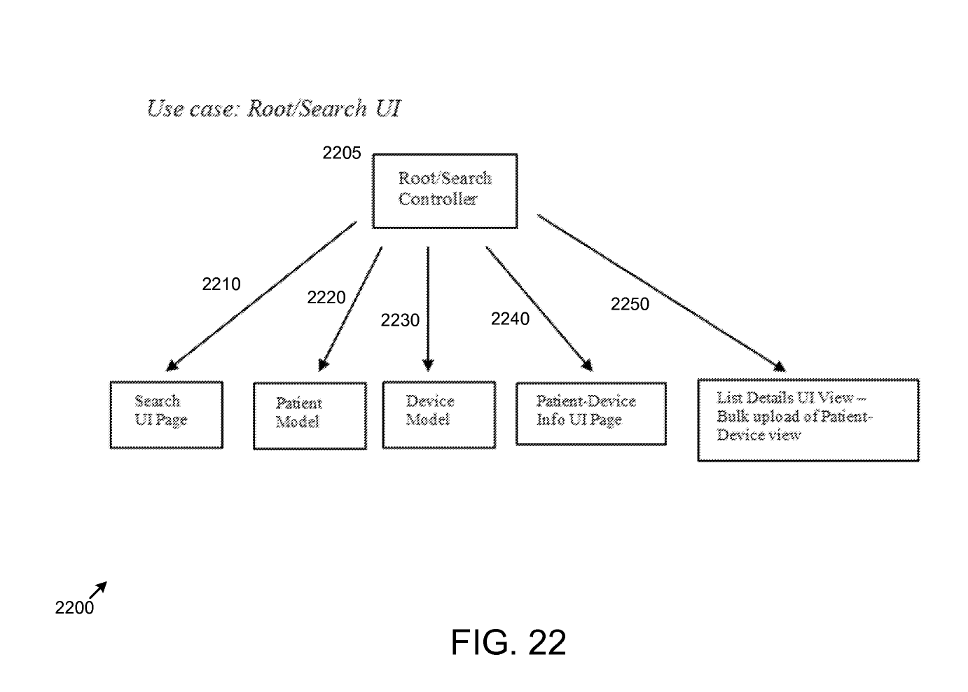

FIG. 22 is a block diagram of an exemplary use case 2200 including search functionality.

The root controller is triggered 2205 when a recall request is received (e.g., from the regulatory body or manufacturer) along with a list of device UDIs for bulk recall; when the patient communicates with the healthcare provider requesting a recall based on the patient's identifier or device UDI; or a request for patient-device information is received from the electronic medical records system or any other related systems.

The control invokes the user interface to input the search variables 2210 (e.g., patient identifier/UDI) or to import the list of UDIs from a file for a bulk recall.

The corresponding model/domain objects are initiated 2220, 2230 which are populated with appropriate data/values.

The patient-device information user interface is displayed 2240, with data input as provided by the patient and device model objects.

The import from file interface 2250 is displayed, allowing the user to upload a list of UDIs, for bulk recall.

### Example 38

### Exemplary Use Case: Billing/Claims UI

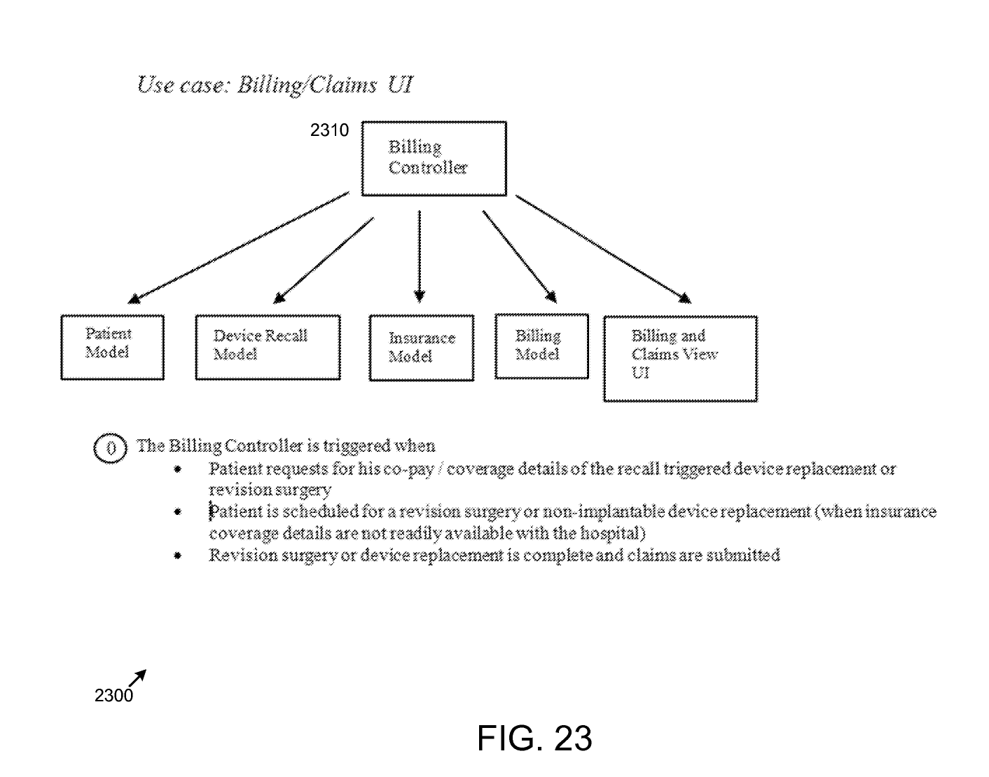

FIG. 23 is a block diagram of an exemplary use case 2300 including billing functionality.

The billing control is triggered 2310 when a patient requests the patient's co-pay or coverage details of the recall-triggered device replacement or revision surgery; the patient is scheduled for a revision surgery or non-implantable device replacement (e.g., when insurance coverage details are not readily available with the hospital); or revision surgery or device replacement is complete and claims are submitted.

### Example 39

### Exemplary Extensions of Technology

The technologies described herein can be extended to cover any of a variety of use cases and scenarios. For example, when a patient is in an Intensive Care Unit (ICU), there are several devices that are used to diagnose and provide therapy. Such devices can include simple items from bandages, syringes, and tracheostomy tubes to complex systems such as multi-parameter patient monitors, ventilation units, infusion pumps, and the like. Many such devices are used to provide treatment only while the patient is in the ICU (e.g., they are not taken outside by the patient).

Thus, the technologies described herein can include a time period associated with a patient-device association. It can then be determined whether the device was used at some time after the recall notification had been issued by the regulatory agency and/or device OEM, or after the recall notification was received and/or acknowledged by the healthcare provider.

The technologies described herein can be used to associate such devices (e.g., via UDI) to the patient during the patient's time spent in the ICU and de-associate them with the devices when the patient moves out of the ICU. Such an approach can provide patient relatives, care provider, regulators, and other stakeholders a clear picture of whether a patient was treated with a recalled or an expired device or not.

In many cases (e.g., emergency, ICU, or other settings), when a device is recalled, care provider personnel (e.g., surgeon, physician, clinician, etc.) make the final decision when it is appropriate to remove the recalled device when it is already being used by a patient (e.g., a life supporting ventilator or tracheostomy tube). The technologies herein can provide an opportunity for the decision maker to document the rationale for not removing the recalled device after receiving the recall notice. Such documentation can play an important role in protecting care providers and patients in light of ever increasing medical device and healthcare regulations and compliance requirements.

So, the technologies described herein can be applied to long term implanted devices (e.g., a pacemaker with a 5-10 year life span) and short-term home use devices (e.g., infusion pumps that are used for a few months for pain management in post-operative care) outside of a hospital setting as well as devices used in an emergency, ICU, hospital temporarily (e.g., from a few hours to several weeks) for treatment.

### Example 40

### Exemplary Applications

The technologies can be implemented as a module in an electronic medical record system used in healthcare facilities to provide ways to manage medical devices implanted, provided to, or used by a patient using the device's unique device identification. A one-stop-shop can be implemented for receiving information about a device recall, sorting out all recalled devices within the care provider facility, sending notifications to the affected patients, tracking patient response, providing patients and care providers with claims and reimbursement details and status, providing meaningful use and compliant records for various government and regulatory authorities, providing evidence for activities provided during a full cycle (e.g., device recall, revision surgery, claims settlement, compliance reporting, etc.). Such activities can involve one or more of a wide variety of stakeholder, including patients, care provider organizations, physicians, clinics, payers, medical device OEMs, pharmaceuticals, and government or other regulatory bodies.

### Example 41

### Exemplary Exception Reports

The technologies described herein can support exception reporting to identify parts of the recall process that have not yet been successful (e g, missing patients, overdue authorizations, or the like). Such features can lead to overall better compliance and more effective recall efforts.

### Example 42

### Exemplary Features

The technologies described herein can manage the complete life cycle of the recall process for medical devices using unique device identification (e.g., a unique device identifier) and the system can be automated to a very high degree, allowing an efficient, more through, and fast process that avoids errors.

### Example 43

### Exemplary Supporting Technologies

Any of a variety of supporting technologies can be incorporated herein. For example, web services definitions specification language (WSDSL) can be used to specify the data structures to be exchanged by entities during the recall process (e.g., over a network).

Publish and subscribe techniques can be used so that healthcare providers and others can subscribe to recall messages. Thus, if a government agency (e.g., FDA) and an OEM decide to recall a particular device, a message can be posted on a nationwide healthcare information network (e.g., NwHIN, NHIN, or similar infrastructure) and consumed by healthcare providers, initiating the recall process at the provider level.

### Example 44

### Exemplary Advantages

The technologies are especially useful in light of the current climate.

The number of new medical devices launched (and thus the number of devices being used) is exponentially increasing.

The number of device recalls are increasing at an alarming rate.

Regulations and legislation associated with recalls is expected to increase in jurisdictions throughout the world. Only those who can perform well in an increasingly complex environment can succeed.

Healthcare providers are already required to have electronic systems in place, but they lack the features described herein.

### Example 45

### Exemplary Database Schema

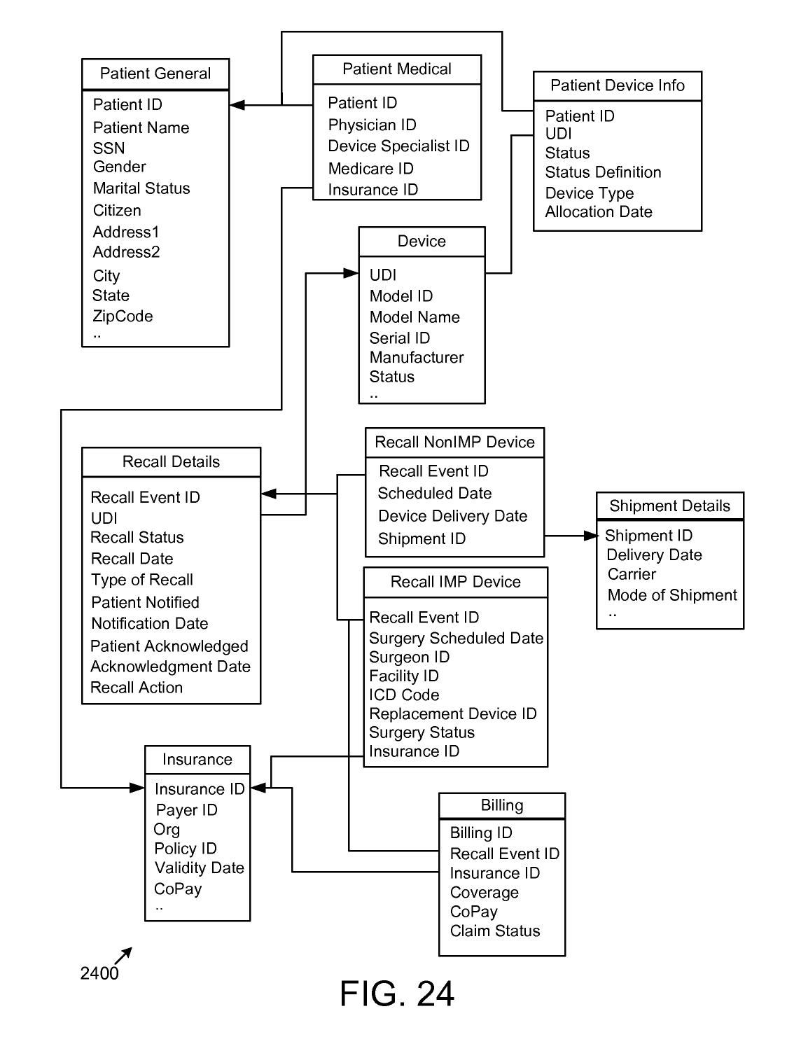

FIG. 24 is a block diagram of an exemplary database schema 2400 for use to implement any of the technologies described herein. The database tables and fields can be implemented in any of a variety of database scenarios.

The healthcare recall management tool can persist the patient-device and recall related data. A general overview of a possible database schema as shown can include the following:

Patient General: contains the general information of the patient Patient Medical: contains medical event related information of the patient (e.g., insurance, Medicare, consulting doctor, etc.)

Patient Device Info:
Relationship between patient and device UDI. At any time, a UDI will belong to only one patient, whereas a patient can have multiple UDIs assigned
Status will be active or inactive
Status Definition indicates if the particular device is safe, recall, pending, or under recall process

Device: contains information about the device such as manufacturer, serial number, model, status (e.g., active, inactive)

Recall Details:
Recall event ID is a unique identifier for the recall event of a particular UDI
Recall Status can be hospital acknowledges, patient notified, patient acknowledges, device replacement scheduled, revision surgery scheduled, etc.
Type of Recall can be class I, class II, etc.
Recall Action can be device replacement, revision surgery, etc.
Recall NonIMP Device: contains information about the non-implantable device to be replaced, shipment details, etc.
Shipment Details: Contains shipment information about the device to be replaced such as pick-up/delivery date, carrier, mode of shipment, etc.
Insurance: contains insurance details of the patient
Recall IMP Device: contains information about the revisions surgery of the implantable device under recall
Billing: contains billing information for the recall (e.g., device replacement, revision surgery, etc.). Claim status can be submitted, verified, pending, approved, or the like.

In practice, additional, different, or other fields and tables can be implemented according to requirements.

### Example—

### Exemplary Computing Environment

The techniques and solutions described herein can be performed by software, hardware, or both of a computing environment, such as one or more computing devices. For example, computing devices include server computers, desktop computers, laptop computers, notebook computers, handheld devices, netbooks, tablet devices, mobile devices, PDAs, and other types of computing devices.

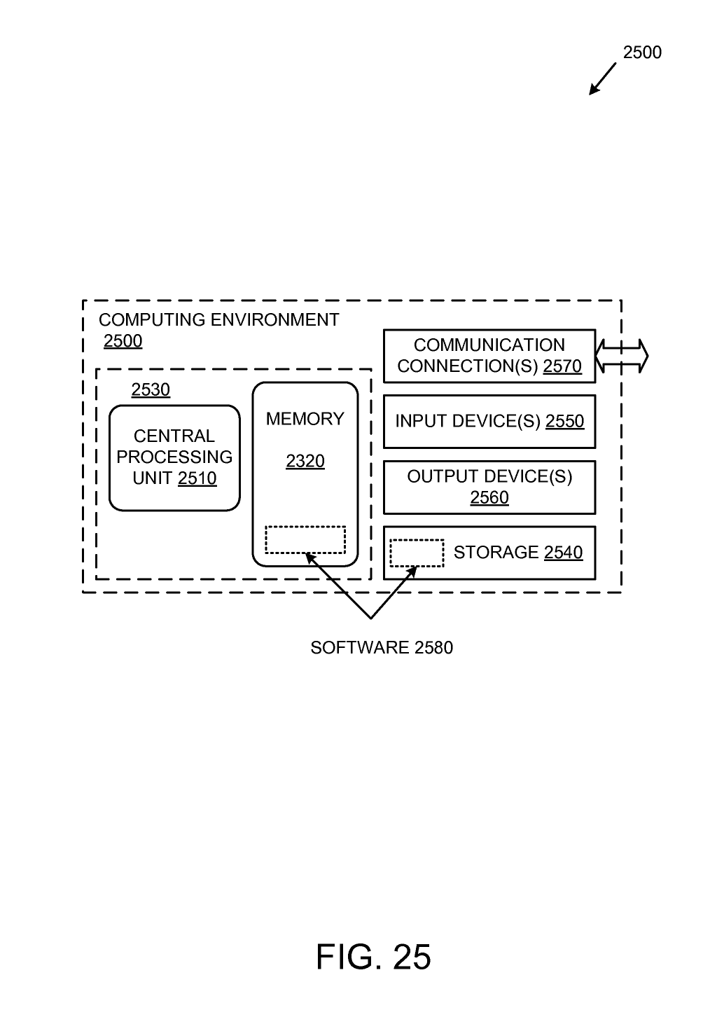

FIG. 25 illustrates a generalized example of a suitable computing environment 2500 in which the described technologies can be implemented. The computing environment 2500 is not intended to suggest any limitation as to scope of use or functionality, as the technologies may be implemented in diverse general-purpose or special-purpose computing environments. For example, the disclosed technology may be implemented using a computing device comprising a processing unit, memory, and storage storing computer-executable instructions implementing the mobile payment technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices.

With reference to FIG. 25, the computing environment 2500 includes at least one processing unit 2510 coupled to memory 2520. In FIG. 25, this basic configuration 2530 is included within a dashed line. The processing unit 2510 executes computer-executable instructions and may be a real or a virtual processor. In a multi-processing system, multiple processing units execute computer-executable instructions to increase processing power. The memory 2520 may be volatile memory (e.g., registers, cache, RAM), non-volatile memory (e.g., ROM, EEPROM, flash memory, etc.), or some combination of the two. The memory 2520 can store software 2580 implementing any of the technologies described herein.

A computing environment may have additional features. For example, the computing environment 2500 includes storage 2540, one or more input devices 2550, one or more output devices 2560, and one or more communication connections 2570. An interconnection mechanism (not shown) such as a bus, controller, or network interconnects the components of the computing environment 2500. Typically, operating system software (not shown) provides an operating environment for other software executing in the computing environment 2500, and coordinates activities of the components of the computing environment 2500.

The storage 2540 may be removable or non-removable, and includes magnetic disks, magnetic tapes or cassettes, CD-ROMs, CD-RWs, DVDs, or any other computer-readable media which can be used to store information and which can be accessed within the computing environment 2500. The storage 2540 can store software 2580 containing instructions for any of the technologies described herein.

The input device(s) 2550 may be a touch input device such as a keyboard, mouse, pen, or trackball, a voice input device, a scanning device, or another device that provides input to the computing environment 2500. For audio, the input device(s) 2550 may be a sound card or similar device that accepts audio input in analog or digital form, or a CD-ROM reader that provides audio samples to the computing environment. The output device(s) 2560 may be a display, printer, speaker, CD-writer, or another device that provides output from the computing environment 2500.

The communication connection(s) 2570 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Computer-Readable Media and Devices

Any of the computer-readable media herein can be non-transitory (e.g., memory, magnetic storage, optical storage, or the like).

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

Any of the methods described herein can be implemented by computer-executable instructions stored in one or more computer-readable storage devices (e.g., memory, magnetic storage, optical storage, or the like). Such instructions can cause a computer to perform the method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method implemented at least in part by a computing system, the method comprising:
receiving a unique device identifier designated as associated with a medical device under recall;
identifying a patient with whom the unique device identifier is associated as having the medical device under recall; and
via the unique device identifier, generating a patient message informing the patient with whom the unique device identifier is associated of the recall, wherein generating the patient message comprises determining a communication destination for the patient with whom the unique device identifier is associated.

2. One or more computer-readable storage devices comprising computer-executable instructions causing a computer to perform the method of claim 1.

3. The method of claim 1 further comprising:
displaying a home user interface comprising a patient name and identifying information about the medical device; and
displaying a recall status user interface comprising a recall status of the medical device;
displaying a device recovery user interface comprising recovery information of the medical device;
displaying a billing user interface comprising claim information for the medical device; and
displaying a compliance reporting user interface comprising an indication of reported parameters for the medical device.

4. The method of claim 3 wherein:
displaying the device recovery user interface comprises displaying information for an implantable device.

5. The method of claim 3 wherein:
displaying the device recovery user interface comprises displaying information for a non-implantable device.

6. The method of claim 1 further comprising:
receiving a second unique device identifier designated as associated with inventory of a healthcare provider;
identifying that the second unique device identifier is associated with inventory of the healthcare provider; and
generating a message to an administrator of the healthcare provider informing the administrator of the recall.

7. The method of claim 1 further comprising:
sending the patient message to the communication destination; and
in a log, recording that the patient message has been sent; and
updating a recall status for the unique device identifier.

8. The method of claim 7 wherein:
recording that the patient message has been sent comprises recording a patient identifier, the communication destination, and a date the patient message was sent.

9. The method of claim 8 further comprising:
receiving notification that the patient message bounced; and
recording an indication that the patient message bounced.

10. The method of claim 8 further comprising:
responsive to a request for a compliance report, outputting the log.

11. The method of claim 7 further comprising:
receiving an indication that the patient acknowledges receipt of the patient message; and
recording in a log that the patient acknowledges receipt of the patient message.

12. The method of claim 11 wherein:
the patient message comprises active content comprising a message identifier; and
receiving an indication that the patient acknowledges receipt of the patient message comprises receiving an indication that the active content has been selected.

13. The method of claim 1 further comprising:
receiving an indication that the medical device has been recovered from the patient; and
responsive to receiving the indication, recording that the medical device has been recovered from the patient.

14. The method of claim 1 wherein:
receiving the unique device identifier comprises receiving a bulk load of a plurality of unique device identifiers for a recall; and
recall processing is performed for other unique device identifiers in the bulk load.

15. A method implemented at least in part by a computing system, the method comprising:
receiving a request for a medical record of a patient;
identifying an outstanding medical device recall for the patient; and
responsive to identifying the outstanding medical device recall for the patient, outputting a medical device recall message.

16. The method of claim 15 wherein:
the medical device recall message is output on a record request user interface.

17. The method of claim 15 further comprising:
outputting a patient recall message informing the patient of the outstanding medical device recall;
receiving an indication that the patient acknowledges receipt of the patient recall message; and
recording in a log that the patient acknowledges receipt of the patient recall message.

18. A medical device recall management system comprising:
one or more processors;
memory;
a healthcare recall management tool comprising unique device identifier logic and configured to process patient messages, compliance reports, and user interfaces via a unique device identifier associated with a medical device recall; and
a recall status database storing recall status for a medical device associated with the unique device identifier.

19. The system of claim 18 wherein:
the healthcare recall management tool comprises a programming interface accessible by an electronic medical record system.

20. One or more computer-readable storage media comprising computer-executable instructions causing a computing system to perform a method comprising:
as part of a bulk load process for a medical device recall, receiving a unique device identifier associated with a medical device;
generating a patient recall message to a patient with whom the unique device identifier is associated;
receiving an indication of authorization from a healthcare provider administrator that the patient recall message is authorized to be sent to the patient;
sending the patient recall message to the patient;
recording that the patient recall message has been sent to the patient in a record associated with the unique device identifier;
receiving an indication that the patient acknowledges receipt of the patient recall message;
responsive to receiving the indication that the patient acknowledges receipt of the patient recall message, recording that the patient acknowledges receipt of the patient recall message;
receiving an indication that the medical device has been recovered from the patient;
responsive to receiving the indication that the medical device has been recovered from the patient, recording that the medical device has been recovered from the patient; and
responsive to a request for a compliance report, outputting information indicating that the patient recall message has been sent to the patient, that the patient acknowledges receipt of the patient recall message, and that the medical device has been recovered from the patient.
